(19) United States
(12) Patent Application Publication
(10) Pub. No.: US 2020/0104147 A1
(43) Pub. Date: Apr. 2, 2020

(54) SCRIPTED TASK INSTRUCTIONS

(71) Applicant: TechnicalitiesPlus Inc, Haliburton (CA)

(72) Inventor: Claude Carrier, Oshawa (CA)

(21) Appl. No.: 16/145,455

(22) Filed: Sep. 28, 2018

(51) Int. Cl. G06F 9/451; G06F 9/455; G06F 3/16; G06T 13/20

(52) U.S. Cl. CPC G06F 9/453; G06T 13/20; G06F 3/167; G06F 9/45512

(57) ABSTRACT

A method of providing electronic instructions comprises defining the steps of a task and executing, by a script engine, a script. The script comprises a sequence of steps stored on a computer readable medium. The script is executed by a computing device and the sequence of steps instructs a user how to perform a task. Each of the sequence of steps comprises a question step or a timed step. The execution of the question step proceeds to a next step based on a user activated button. The execution of a timed step proceeds to the next step in response to the expiration of a timer. Each of the sequence of steps is represented by one of a plurality of multi-media interfaces illustrating one of the sequence of steps.

### FIELD OF THE INVENTION

The present invention relates to computer based instructions and more particularly to computer based instructions for people with cognitive disabilities.

### DESCRIPTION OF THE RELATED ART

There exist many solutions in the market place that provide instructions on how to perform a task. Common examples include recipe books, automobile repair, and certification training. In the past, instructions may have been printed, such as a recipe book, instruction book, or user's manual. Other implementations included audio instructions on tape, CD, or DVD. In some cases, audio and visual instructions were combined in video instructions. More recently, there have been computer implemented versions of these traditional forms of instructions that often take the form of a multi-media presentation that includes written material and questions to be answered.

Some people learn very well using these traditional methods, but others do not. For people with cognitive disabilities, there is often a large gap between how instructions are typically presented and their ability to successfully follow such instructions. In fact, the typical set of instructions, whether found in a book or online, poses significant challenges and even obstacles to those who have limitations in areas such as literacy, attention, short term memory, etc.

People, such as individuals who live with a developmental disability, may not be able to read, making following written instructions nearly impossible. Often instructions are too complex in that they condense an entire series of steps into a single instruction. Instructions written in this way pose large and even insurmountable obstacles for some.

There exists a need for methods and systems that provide instructions in a manner that may be understood and followed by people with cognitive disabilities.

### BRIEF SUMMARY

A first major aspect of the invention comprises a method of providing electronic instructions comprising

executing, by a script engine, a script comprising a sequence of steps. Each step is stored on a computer readable medium. The script is executed by a computing device and the sequence of steps instructs a user how to perform a task. Each of the sequence of steps comprising an instruction step, a question step or a timed step. The execution of either an instruction step or a question step proceeds to a next step based on a user activated button. The execution of a timed step proceeds to the next step in response to the expiration of a timer (or the start of a background timer). Each of the sequence of steps is represented by one of a plurality of multi-media interfaces. Each multi-media interface illustrates one of the sequence of steps.

In further embodiments, the execution of the timed step happens in parallel with a second timed step when the timed step and subsequent steps are flagged to allow background execution.

In further embodiments, each of the plurality of multi-media interfaces comprises verbal, written and image cues.

In other embodiment, the image cues are selected from the group comprising an action, an object, a qualifier, a tool, and a location.

In some embodiments, the plurality of multi-media interfaces comprises an avatar.

In further embodiments, the plurality of multi-media interfaces comprises an image representing a completion of the task.

In other embodiments, the plurality of the sequence of steps comprises a yes/no decision.

In other embodiments, an audible alert is generated when the timer expires.

In other embodiments, each of the sequence of steps is stored in database records.

In further embodiments, the sequence of steps comprises an action and the multi-media interface comprises a next button and a back button.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a Start Page 100 in accordance with one embodiment.

FIG. 2 illustrates a first simple step 200 in accordance with one embodiment.

FIG. 3 illustrates a subsequent simple step 300 in accordance with one embodiment.

FIG. 4 illustrates a final simple step 400 in accordance with one embodiment.

FIG. 5 illustrates a basic step 500 in accordance with one embodiment.

FIG. 6 illustrates a question step 600 in accordance with one embodiment.

FIG. 7 illustrates a question step 600 in accordance with one embodiment.

FIG. 8 illustrates a basic timer 800 in accordance with one embodiment.

FIG. 9 illustrates a question step 600 in accordance with one embodiment.

FIG. 10 illustrates a background timer where all ABE steps are complete before the timer goes off 1000 in accordance with one embodiment.

FIG. 11 illustrates a background timer where not all ABE steps are completed before the timer goes off 1100 in accordance with one embodiment.

FIG. 12 illustrates a background timer where not all ABE steps are completed before the timer goes off during a high priority step. 1200 in accordance with one embodiment.

FIG. 13 illustrates a database records 1300 in accordance with one embodiment.

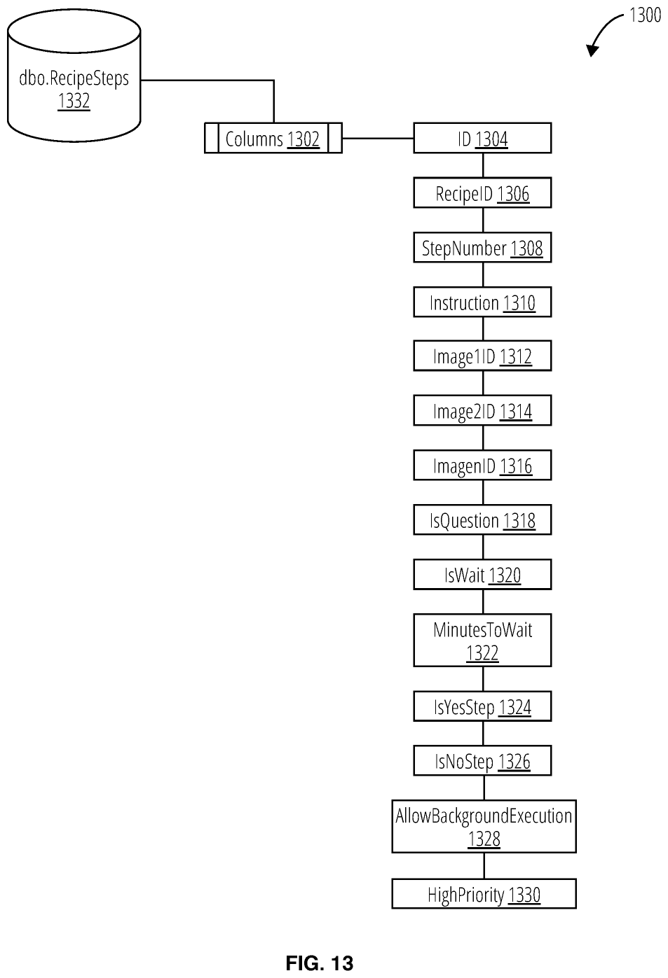

### DETAILED DESCRIPTION

The present invention is direct to computer implemented instruction and more particularly to systems and methods of computer implemented instruction for people with cognitive disabilities that make it difficult to follow conventional instructions. The system comprises a user terminal which may be a mobile device (smartphone, tablet), laptop computer, desktop computer with integrated input and output devices. It may also comprise a separate dedicated input device such as a touch screen device or keypad, in communication with a dedicated output device, such as a television. The software comprises an end user interface (user application) and a management user interface which may be part of the same application or be separate applications. The user application may be a standalone application, mobile app, web application running in a web browser, or be some type of software as a service (SaaS) interface. The management user interface will typically run on a laptop or desktop computer to simplify data entry though other computing devices may also be used. A database is used to store the sequence of steps that make up the task. The database may be located on the user terminal, management device, or a separate server. It may be located on a single device or be distributed over multiple computing devices. The user terminal, management device, and database server are all in communication with each other though the wired or wireless connection between devices may be intermittent.

Embodiments according to a first major aspect of the invention comprises Assisted Cooking (AC) recipes. The task of cooking a recipe will be used as an example within this document though it is understood that other embodiments may implement other types of instructions to perform a wide variety of tasks.

AC recipes are computer implemented, multimedia cooking recipes. The steps of the recipe are broken down via task analysis, into steps that are manageable for the individual doing the cooking.

Assisted Cooking (AC) assumes that there is at least one cook and at least one Supporting Person (SP) providing support. The Supporting Person (SP) has login access to a “Management” user interface (UI) which allows them to manage recipes, images, a menu, etc. The primary purpose of the Management UI is to store recipe information (Recipes and Recipe Steps) in such a way as to enable the Cooking interface to correctly render the recipe to the Cook.

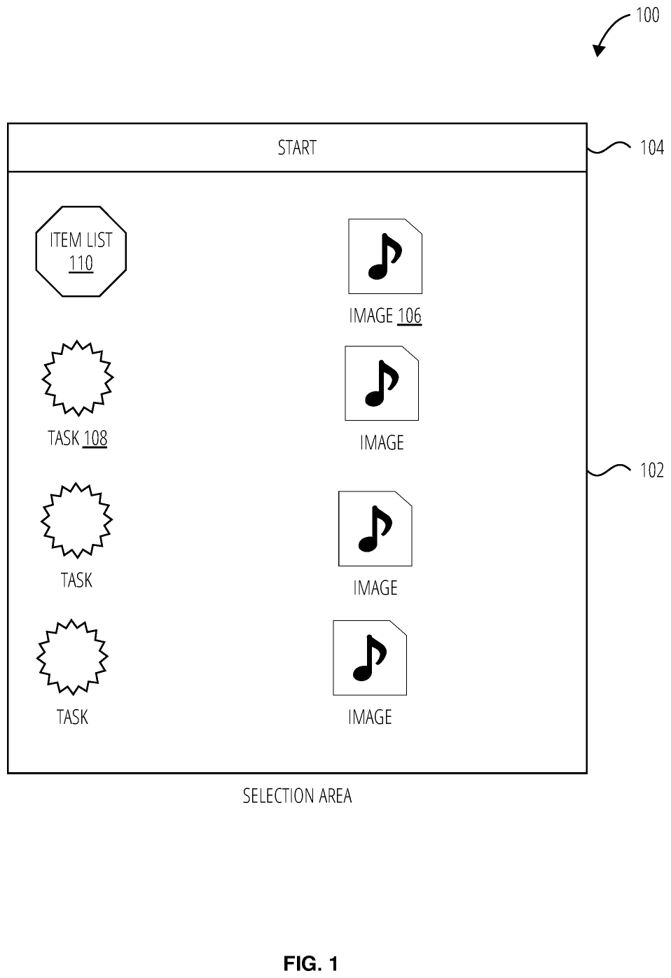

FIG. 1 illustrates an embodiment of a Start Page 100. The Start Page 100 is presented to a user. The Start Page 100 presents the end user with the available tasks 108 to choose from and may include such options as a meal that has been scheduled on the menu, favorite recipes, and an item list 110 required to complete the task, such as a grocery list for recipes. Selecting the task to be performed initiates the sequence of steps that make up the task. In some embodiments, the Start Page 100 will be designed so that the end user does not need to log in or authenticate in order to perform the task. Selecting the task, image, row, or other indicator for the task will cause the first step in the sequence of steps to be displayed.

The Start Page 100 may be simplified, for example only showing a task that is scheduled to be done at the current date and time. The Start Page 100 may also be more advanced and include a number of tasks, item lists, etc. It may also indicate tasks that have been designated as “favorites”, recently performed tasks, newly added tasks, a level of difficulty for tasks, etc. Tasks may be grouped or organized into menus, levels, etc.

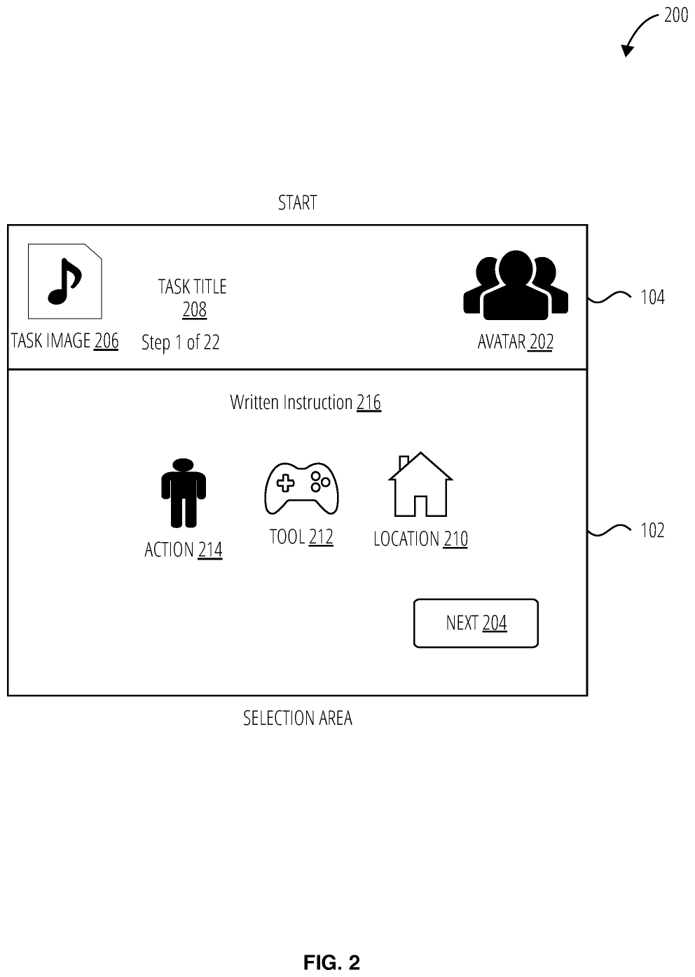

FIG. 2 illustrates the basic user interface used by the cooking interface of embodiments of the invention. The user interface comprises a Start 104 and a selection area 102. The Start 104 comprises an image of the completed task, in this case the meal that is being prepared, and remains throughout. The task title 208, in this case the name of the recipe also remains visible throughout. When one or more timers are counting down in the background, timer information is presented in this area as well. Also included in the Start 104 is an avatar 202. The avatar 202 complements text-to-speech functionality and may be used to greet the cook on start up, read each instruction step out loud, to give an audio alert to gain the cook's attention, and other verbal functions.

The selection area 102 comprises the written instruction 216, a series of descriptive visual elements, and navigation buttons. Visual elements may be images, video, animations, or other graphical elements. Descriptive images provide a visual representation of the displayed written instruction 216 and will typically include between one and six images. Images can comprise an action 214 image, a tool 212 image, a location 210 image, objects such as food items, qualifiers such as “on” or “into”, and settings such as “high” or “low”. The action image represents the verb in the instruction and illustrates the type of action that should be taken, for example an image of a hand to take an item from the cupboard. The tool 212 represents the tool or object to be used to perform the step, for example a measuring cup to measure flour. The location 210 image may represent where the tool is located or where the action should be performed. For example, if the flour is stored in the cupboard, and image of the open cupboard may be used. FIG. 2 illustrates a first simple step 200 in the sequence and the user is presented with a single navigation button, the next button 204, that when pressed causes the system to display and read the next step.

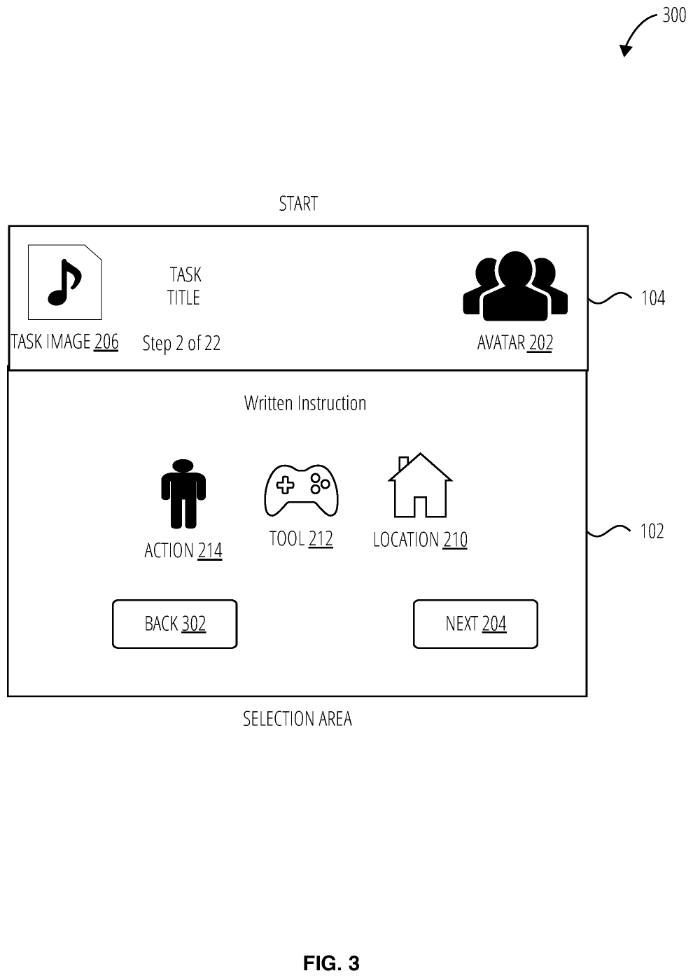

FIG. 3 illustrates a similar basic interface to that of FIG. 2. FIG. 3 illustrates the case of a subsequent simple step 300 that is not the first or last step in the instructions. In this case the additional back button 302 is displayed that, when pressed, displays and reads the previous step.

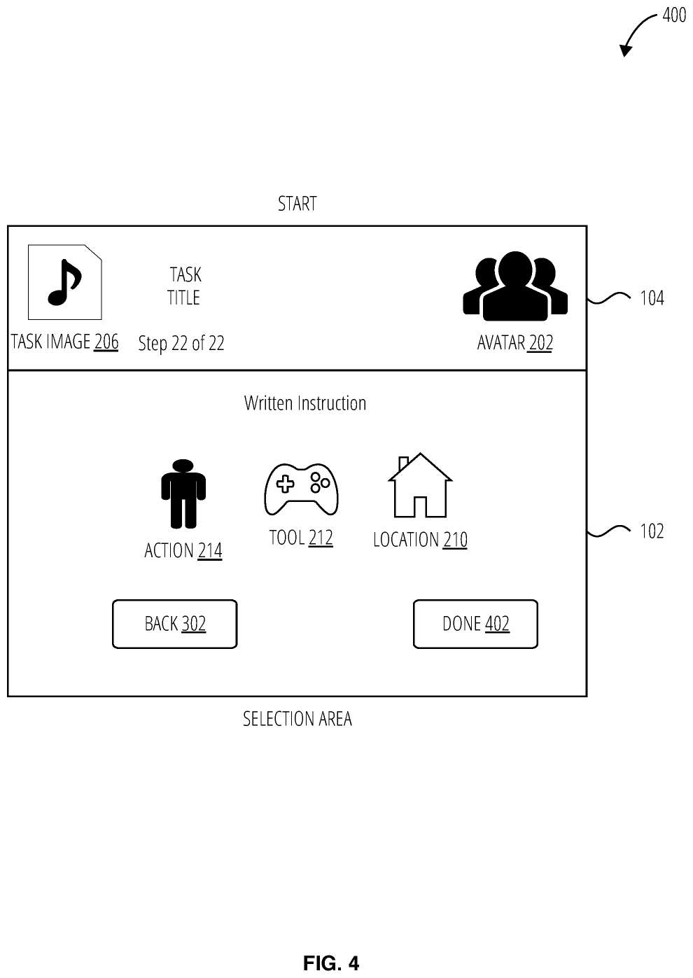

FIG. 4 illustrates a basic interface that is the final step in the instructions. In this case the next button 204 is replaced with a done button 402 that indicates that the instructions are now complete, and the instruction flow goes back to the Start Page 100.

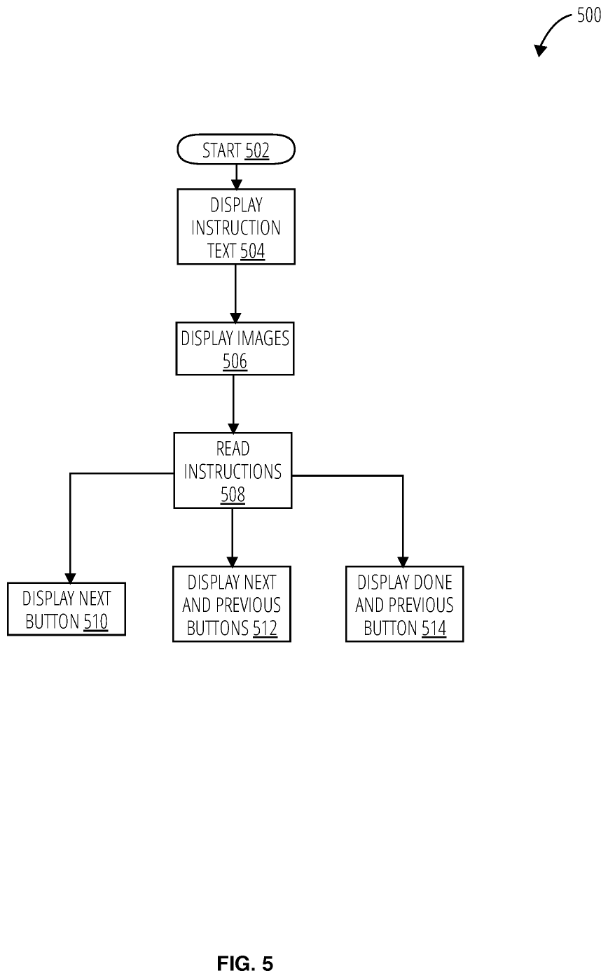

FIG. 5 illustrates a flowchart for a basic step 500 of which examples have been given in FIG. 2, FIG. 3, and FIG. 4. When the AC system reads a basic step 500 it prepares the correct interface as shown in FIG. 2, FIG. 3, and FIG. 4, depending on the position of the step in the sequence of steps. The written instruction 216 text is displayed, descriptive images are displayed and the avatar 202 is triggered to read the instructions. The relevant buttons, next button 204, back button 302, done button 402, are also displayed.

In embodiments of the invention each instruction is presented as text written instruction 216, verbally via the avatar 202, and in images. This allows users with cognitive disabilities to perceive and comprehend each step in their own way, especially if they have difficulty reading or are unable to read. Each task is also broken down into simple, manageable steps. The navigation buttons present the user or Cook with a simple interface of one or two buttons that allows them to indicate that they have finished a step and can proceed to the next one. This allows the user to perform the task at their own pace.

The system also supports complex steps. A complex step consists of a basic step with additional attributes. These attributes tell the Cooking UI how to process the step. Each complex step supports advanced functionality of two main types, Questions and Timers.

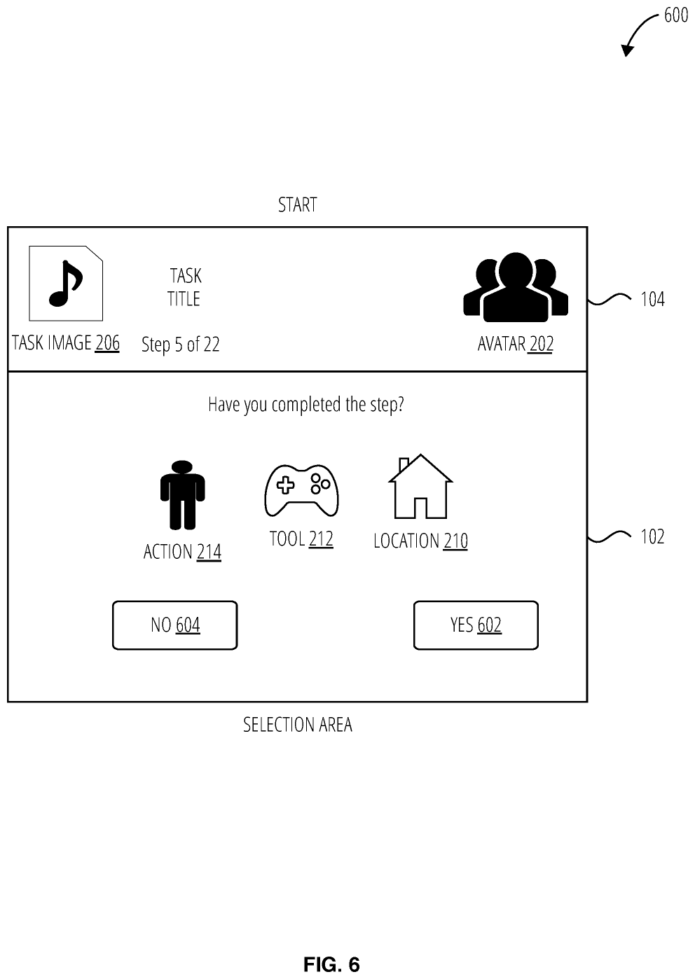

FIG. 6 illustrates a question step 600. The user interface is similar to the previous basic step 500 but the cook is presented with a yes button 602 and a no button 604. If the cook presses the yes button 602 the instruction sequence skips over the immediate next step and continues executing the recipe. If the cook presses the no button 604 it causes the immediate next step to be executed. When the cook completes that step, the UI goes back to the question step 600 and asks the questions again. For example, a question might be, “Are the potatoes cooked?” and the immediate next step could be to Wait 5 more minutes. If the Cook answers No to the question, they are made to wait for five minutes before the question is repeated. The above will continue to repeat until the Cook answers Yes.

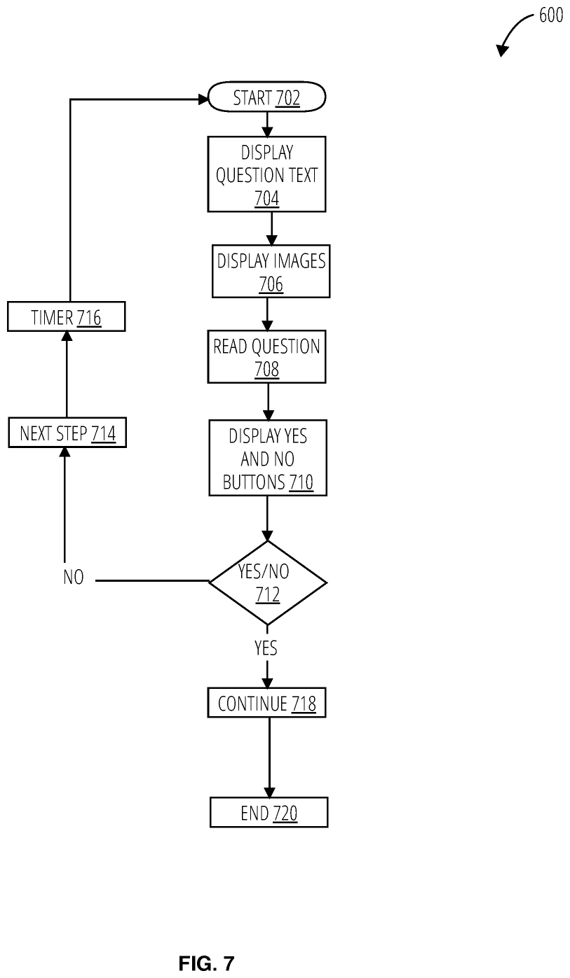

The flowchart of FIG. 7 illustrates the execution of a question step 600. The step immediately following a question step is typically a wait instruction that initiates a timer. The continue step is the next instruction to be displayed after the question step 600 has been answered in the affirmative by the cook pressing the yes button 602.

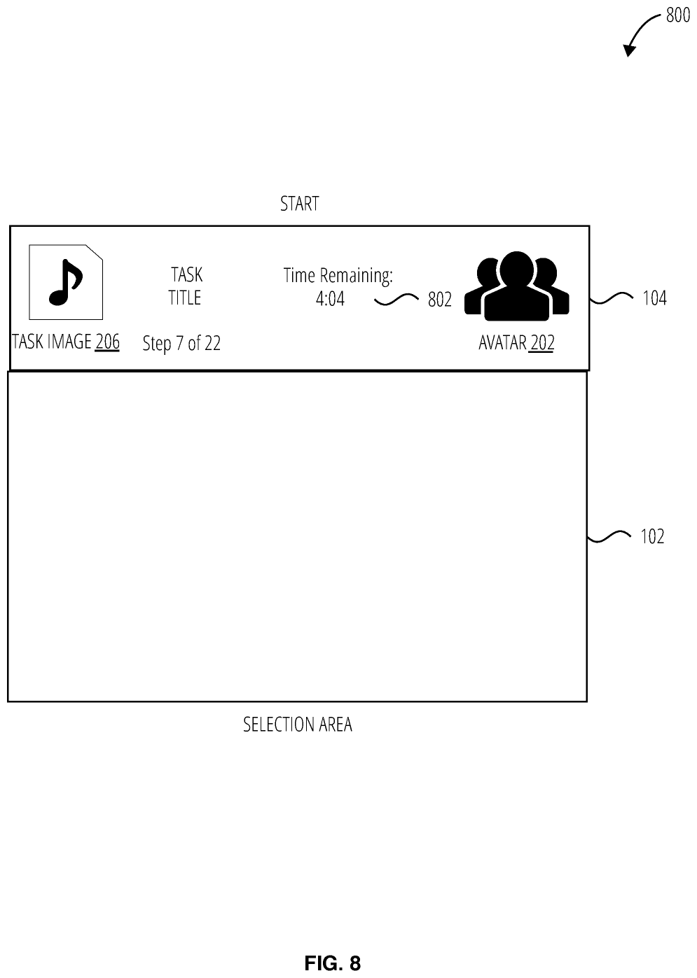

The AC system supports wait steps that are implemented using the basic timer 800 as shown in FIG. 8. The basic timer 800 utilizes the familiar user interface of the Start 104 and selection area 102. The timer sets and displays a countdown timer and hides the navigation buttons forcing the user to wait till the timer has finished counting down before they can do anything else. When a basic timer 800 goes off (i.e. finishes counting down), the avatar 202 announces the event to draw the Cooks attention back and displays a next button 204. The avatar 202 announces that the timer has gone off and will repeat this message periodically (for example, every twelve seconds) until the Cook clicks on the next button 204. The rate at which the message is repeated is subject to change and may be made configurable to meet the individual's preference and ability.

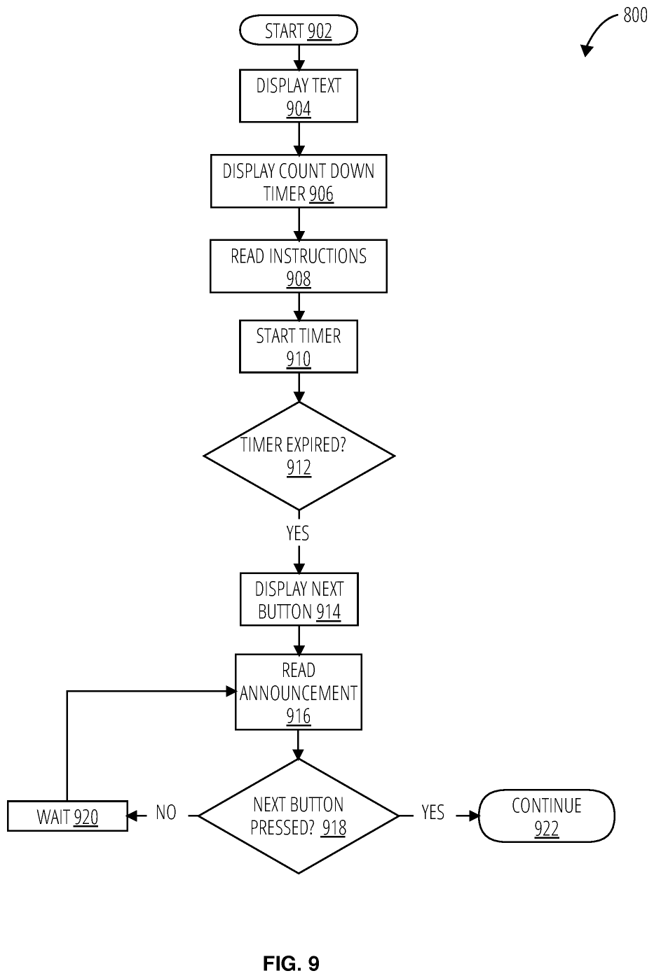

A flowchart of the instruction sequence of a basic timer 800 is shown in FIG. 9.

Background timers differ from basic timers in that, while basic timers force the use to wait before executing any further steps, background timers, as their name implies, count down in the background, allowing the user to be doing things in parallel. Using the example where the task is a recipe, the cook could be using a background timer to track the time that potatoes are boiling while at the same time completing other steps to prepare a salad. The program UI determines whether to use a basic or background timer based on whether the timer step is marked as Allow Background Execution (ABE) and whether any steps that follow are marked as ABE and have not yet been executed. Steps may also be flagged as high priority which indicates to the program that they may not be interrupted.

Steps with the ABE flag set are executed, in step order, while the timer counts down in the background. When the timer goes off, execution continues as follows: If the current step is not tagged as high priority, the system interrupts the current step (i.e. does not wait for the user to indicate that the step has been completed) and execution jumps back to the first step after the Wait instruction (that initiated the count-down timer) that is not marked with the ABE flag. If the current step is tagged as high priority, the application allows the cook to complete this step and all consecutive high priority steps and only jumps back when it encounters the first non-high priority step. The high priority flag allows certain steps to have higher priority in order to make sure they are not interrupted when a timer goes off. For example, if a background timer goes off as the Cook reaches a step that instructs them to turn a burner off and the next step directs the Cook to move the pan to a different burner, it is important that these steps get executed before going back to the original sequence. After jumping back, execution continues in step order, jumping over any steps that were completed, as background steps, while the timer was counting down.

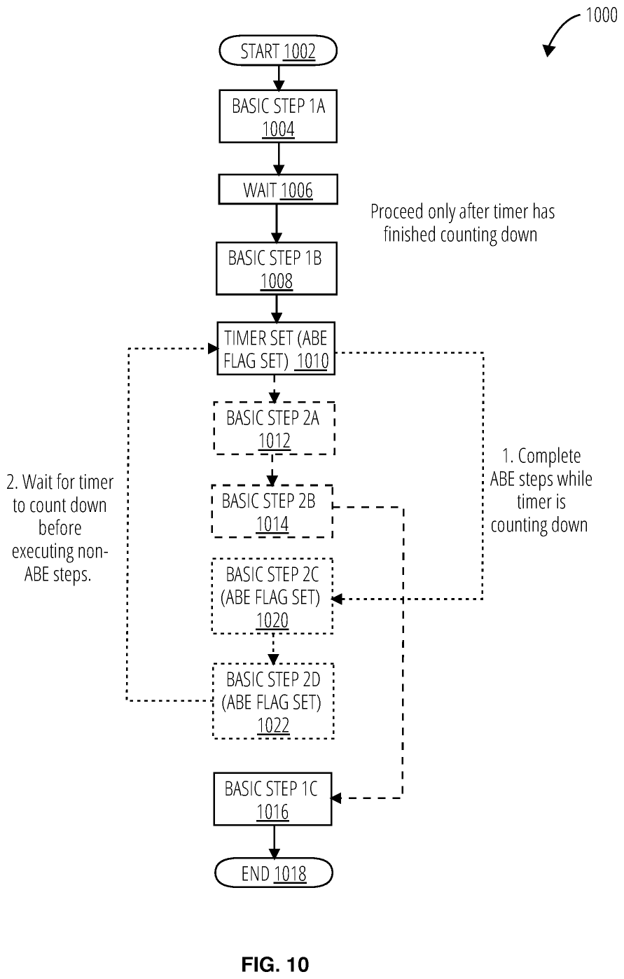

FIG. 10 illustrates an embodiment of a background timer where all ABE steps are complete before the timer goes off 1000. Step 1010 comprises a background timer with the ABE flag set. The ABE flag is also set on subsequent steps 1020, and 1022 allowing for background execution of these steps. While the timer of 1010 is running, the program will skip steps 1012 and 1014 since they don't have their ABE flags set and therefore, cannot be executed in the background. In this case, the user is able to complete steps 1020 and 1022 before the timer runs out. At the completion of step 1022, the user must wait for the timer to go off before being allowed to branch back to perform the non-ABE steps, 1012, 1014, and 1016 in sequence.

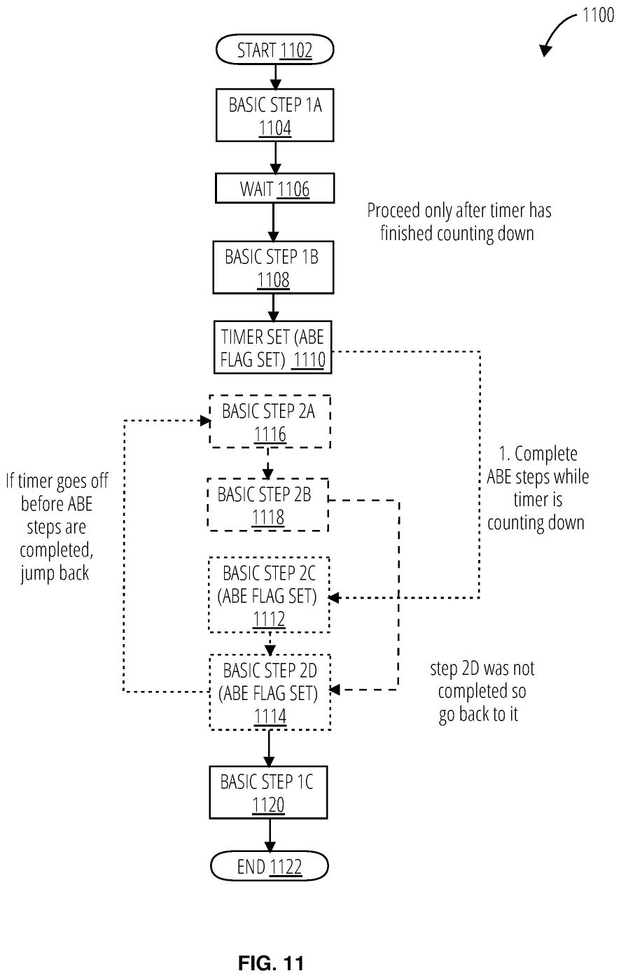

FIG. 11 illustrates an embodiment of a background timer where not all ABE steps are completed before the timer goes off 1100. Step 1110 comprises a background timer with the ABE flag set. The ABE flag is also set on subsequent steps 1112, and 1114 allowing for background execution of these steps. While the timer of 1110 is running, the program will skip steps 1116 and 1118 since they don't have their ABE flags set and therefore, cannot be executed in the background. In this case, the user is only able to complete steps 1112 before the timer runs out. The timer goes off while the user is in the process of performing step 1114. Since the high priority flag is not set on step 1114, step 1114 is interrupted and execution jumps to step 1116, the first non-ABE step after the timer step 1110. Execution then proceeds in sequence to step 1118, 1114 (which was previously interrupted) and finally to step 1120.

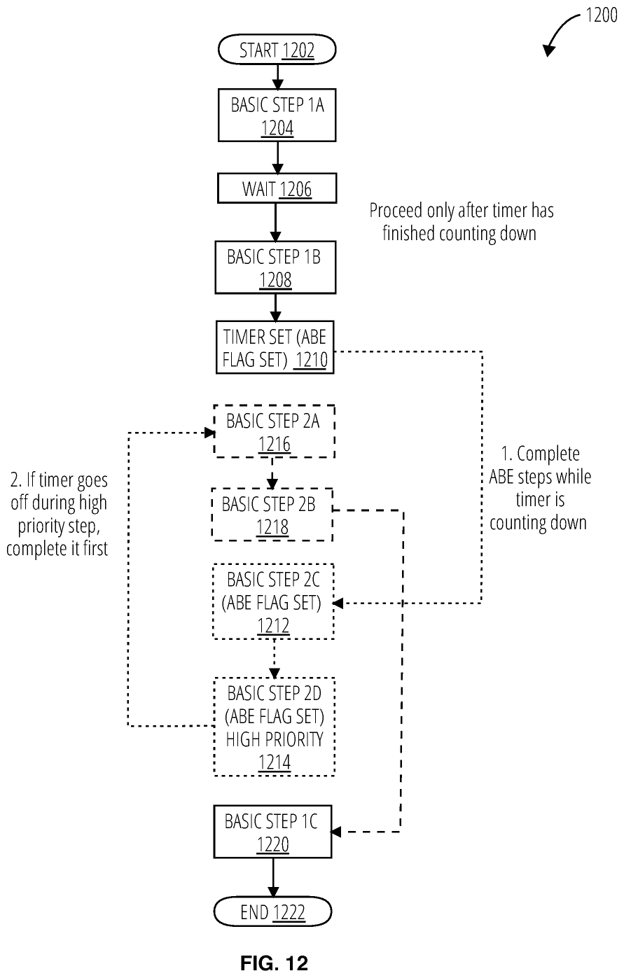

FIG. 12 illustrates an embodiment where a background timer where not all ABE steps are completed before the timer goes off during a high priority step. 1200. Step 1210 comprises a background timer with the ABE flag set. The ABE flag is also set on subsequent steps 1212, and 1214 allowing for background execution of these steps. Step 1214 also has its high priority flag set which prevents it from being preempted. While the timer of 1210 is running, the program will skip steps 1216 and 1218 since they don't have their ABE flags set and therefore, cannot be executed in the background. In this case, the user is only able to complete steps 1212 before the timer runs out. The timer goes off while the user is in the process of performing step 1214. Since the high priority flag is set on step 1214, step 1214 is not interrupted and the user is allowed to finish this step. After the completion of high priority step 1214 execution jumps to step 1216, the first non-ABE step after the timer step 1210. Execution then proceeds in sequence to step 1218, and to step 1220.

Note that in this example step 1214 is a single high priority, ABE step. If there are other contiguous or consecutive high priority, ABE steps, they would also be completed before jumping to non-ABE steps.

In embodiments of the invention the sequence of steps that make up the instructions are stored as records in a database with one record per step. ID 1304 is an index to the step used to access the step in the database records 1300. RecipelD 1306 is a key that identifies the overall task that is the subject of the instructions. StepNumber 1308 is the number of the step in the sequence. Instruction 1310 is the text for the written instruction 216 of the step. Indexes or pointers to images used for tool 212, action 214, and location 210 are stored in a series of fields labeled Image1ID 1312, Image2ID 1314, ..., ImagenID 1316. If the step is a question, fields IsQuestion 1318, IsYesStep 1324, and IsNoStep 1326 are used. If the step is a timer, the fields IsWait 1320, MinutesToWait 1322, AllowBackgroundExecution 1328, and HighPriority 1330 are used.

A user may access the system in a variety of ways. In some embodiments, a user utilizes a terminal and uses a predetermined URL that is specific to their account, role, user group, or other classification. Accessing the URL presents them with the Start Page 100 that displays a selection of tasks that have been configured for them by an administrator. Other URLs may cause the first step in the sequence of steps for that task, thereby bypassing the Start Page 100. In some embodiments, users don't manage the task list. Clicking on the tasks in this area launches those tasks for the user.

An administrator is also provided with a management user interface (UI). The management UI allows an administrator to manage tasks (i.e. recipes), edit task steps, manage images, group tasks into plans, generate list of supplies or ingredients that may be required to perform the tasks, manage user account details and configuration options. The management user interface may also allow a user to conduct a trial or test of the task instructions by running the sequence of steps with all timers set to a minimal time, such as 10s. Each administrator will have their own login credentials to allow them to manage tasks for specified users associated with their account.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

What is claimed is:

1. A method of providing electronic instructions, the method comprising:
executing, by a script engine, a script, the script comprising a sequence of steps, each step stored on a computer readable medium, the script being executed by a computing device, the sequence of steps instructing a user how to perform a task, each of the sequence of steps comprising an instruction step, a question step or a timed step;
the execution of the question step proceeding to a next step based on a user activated button;
the execution of a timed step proceeding to the next step in response to the expiration of a timer for a simple timer and proceeding to the next ABE step when the timer starts; and
each of the sequence of steps being represented by one of a plurality of multi-media interfaces, each multi-media interface illustrating one of the sequence of steps.

2. The method of claim 1 wherein the execution of the timed step happens in parallel with a second step when the timed step and subsequent steps are flagged to allow background execution.

3. The method of claim 1 wherein each of the plurality of multi-media interfaces comprises verbal, written and image cues.

4. The method of claim 3 wherein the image cues are selected from the group comprising an action, an object, a qualifier, a tool, and a location.

5. The method of claim 1 wherein the plurality of multi-media interfaces comprises an avatar.

6. The method of claim 1 wherein the plurality of multi-media interfaces comprise an image representing a completion of the task.

7. The method of claim 1 wherein the plurality of the sequence of steps comprises a yes/no decision.

8. The method of claim 7 wherein an audible alert is generated when the timer expires.

9. The method of claim 7 wherein each of the sequence of steps is stored in database records.

10. The method of claim 1 wherein the sequence of steps comprises an action and the multi-media interface comprises a next button and a back button.
